(19) United States
(12) Patent Application Publication
(10) Pub. No.: US 2006/0213632 A1
(43) Pub. Date: Sep. 28, 2006

(54) Glass-forming die and method

(75) Inventors: Russell G. Vogt, Yorktown, VA (US); Kenneth S. Murphy, Muskegon, MI (US); John He, Muskegon, MI (US); Robert J. Hrubec, Saddle Brook, NJ (US); Gail R. Cole, Muskegon, MI (US); Robert E. Grunstra, Spring Lake, MI (US)

Correspondence Address: Mr. Edward J. Timmer, P.O. Box 770, Richland, MI, 49083-0770, US

(73) Assignee: Howmet Corporation

(21) Appl. No.: 11/371,184

(22) Filed: Mar. 8, 2006

Related U.S. Application Data
(60) Provisional application No. 60/660,919, filed on Mar. 11, 2005.

(51) Int. Cl. B22D 7/10; C03B 9/38; C03B 9/48; C03B 11/12

(52) U.S. Cl. 164/6; 65/356; 65/374.12

(57) ABSTRACT

Glass-forming die, such as a parsain-forming or bottle-forming die, includes a die body having a molding surface with a curved contour to form at least a portion of a glass bottle or other article to be made. The die body has one or more cooling passages inside the body wherein the cooling passages is/are non-linear (non-straight) along at least a portion of their length to improve temperature control of the die during the glass forming operation. To this end, the cooling passages are curved in a manner to generally follow the curved contour along at least a portion of the length of the curved contour, and may include heat radiating or turbulating elements in the cooling passage. The glass-forming die alternately, or in addition, can include integral cooling fins, ribs or other heat radiating element on one or more exterior regions of the die.

This application claims benefits and priority of provisional application Ser. No. 60/660,919 filed Mar. 11, 2005.

### FIELD OF THE INVENTION

The present invention relates to a glass-forming metallic die and method providing improved cooling of the glass-forming surface of the die.

### BACKGROUND OF THE INVENTION

Current glass bottle molding processes consist of three main steps. First, a small portion of glass, called a ‘gob’, drops in a pre-measured amount from a liquid glass holding tank above a high speed glass bottle forming machine. This gob falls into a die called a ‘blank’ mold, which is typically made of cast iron. The blank mold includes a cavity to receive the glass gob and configured to form an intermediate bottle shape known as a parison. The parison is then removed from the blank mold and moved to a final or finish die having a cavity with the final bottle shape and markings to be imparted to the bottle. In the final or finish die, the parison is blown using compressed air into the final bottle shape. The final or finish die is typically made of an alloy such as nickel-bronze.

The entire bottle molding process from the parison stage to the final bottle stage takes approximately 8-10 seconds. Of this time, each molding process takes approximately 4 seconds and the balance is transfer time between the initial die (i.e. blank mold) and final or finish die. Removal of heat from the surface of the glass gob in the blank die is critical. If too much heat is removed, the parison will not be plastic enough to be formed to final shape in the final or finish die, resulting in formation of a defective bottle. If too little heat is removed, the parison may be too plastic during transfer to the final or finish die. For example, the temperature of the parison typically is maintained within a range of about 25-40 degrees F. of a nominal parison temperature value in some bottle making processes.

The current state-of-the-art cast iron blank molds for glass making are cast into shape or machined from preforms into the required desired die shape. The blank mold is provided with a plurality of straight cooling air passages which are gun drilled into the mold body along its length from one end to the other. During operation of the bottle forming machine, the cooling air holes of the blank mold receive cooling air which is blown onto the blank mold.

The gun drill process only allows for straight cooling air passages. Consequently, the distance from the cooling holes or passages to the blank mold cavity surface (and therefore the molten glass) varies considerably along the length of the blank mold and the ability to change that distance is extremely limited. Cooling adjustments of the blank mold are made as needed by plugging certain cooling holes or passages, or machining sections of the blank mold.

Another integral part of the glass bottle manufacturing process is the application of a carbonaceous lubricant to the dies in intervals of approximately 20 minutes. The application of the lubricant is a manual process which requires the operator to be in close proximity to moving components of the glass bottle forming machine and molten glass and results in some scrap bottles as the excess lubricant ‘burns off’. Non-uniform cooling of the initial die (blank mold) can cause mold ‘hot spots’, which in turn allow the molten glass to stick to the blank mold cavity. Eventually (over approximately 3-4 months), the dies can no longer be successfully lubricated and are replaced. The reasons for this phenomenon is not completely understood but may be related to oxidation of secondary phases in the cast iron or thermal mechanical fatigue cracking. Both mechanisms lead to void or crack formation which can capture bits of molten glass.

There thus is a need for improved dies for use in the manufacture of glass bottles as described above as well as for a method of making such dies.

### SUMMARY OF THE INVENTION

The present invention provides a glass-forming die having features for improving control of heat removal from the die to thereby provide a desired temperature profile, uniform or non-uniform, of glass material molded in the die body.

Pursuant to an embodiment of the invention, the glass-forming die comprises a die body having a molding surface with a curved contour to form at least a portion of a glass article to be made. The die body includes one or more cooling passages through which a cooling fluid passes inside the body to remove heat. In one embodiment, the cooling passage(s) is/are non-linear (non-straight) along at least a portion of its/their length in a manner to improve uniformity of heat removal from the die body when the cooling fluid passes therethrough. Alternately, the cooling passage(s) can be non-linear (non-straight) along at least a portion of its/their length in a manner to provide a desired temperature profile, uniform or non-uniform, at the molding surface. The die can comprise a blank mold (parison-forming die) and/or a finish die (bottle-forming die) for use in a bottle forming machine.

Pursuant to another embodiment of the invention, the glass-forming die comprises a die body having a molding surface with a curved contour to form at least a portion of a glass article to be made. The die body includes one or more heat radiating elements such as projections including, but not limited to, cooling fins, posts, pins, and/or ribs, extending from the exterior of the die body in a manner to improve removal of heat from that region. The die body preferably includes a substantially constant cast wall thickness such that the back (outer) side of the die body has the same contour as the molding surface in that region of the die body.

The glass-forming dies pursuant to certain embodiments of the invention are investment cast, or otherwise cast, using refractory molds having fugitive refractory cores therein when the dies include the cooling fluid passage(s) in the cast die pursuant to a particular method embodiment of the invention. The glass-forming dies pursuant to other embodiments of the invention are investment cast, or otherwise cast, using tubular insert members about which the die body is cast so that the tubular insert members become permanently incorporated in the die body and form cooling passages therein through cooling fluid can flow. The glass-forming dies pursuant to still other embodiments of the invention are made by consolidating metallic powder material about cores or tubular insert members.

The dies preferably comprise metal alloys having resistance to degradation in air and to molten glass at the elevated temperatures employed in the glass forming operation. The dies can be cast or otherwise formed in a manner to provide a die microstructure having a coarse grain size or a fine grain size, which can be a beneficial very small and/or cellular grain size of ASTM 2 or less.

Glass-forming dies pursuant to the invention are advantageous to improve uniformity of heat removal from the die body and thereby maintain a more uniform temperature of glass material molded in the die body, such as a parison used in manufacture of a glass bottle wherein, for example, parison temperature must be maintained within a range of 25 to 40 degree F. of a nominal parison temperature value. Alternately, glass-forming dies pursuant to the invention are advantageous to provide a controlled temperature profile, uniform or non-uniform, of glass material (for example, a parison) molded in the die body. Moreover, the invention can be practiced to improve die life via selection of materials which are resistant to degradation, such as oxidation and thermal fatigue, and which require less lubrication over time. A benefit of the invention may be the ability to run glass-forming machines at higher speed, thus allowing more production volume without increasing capital investment.

Other advantages, features, and embodiments of the present invention will become apparent from the following description.

### DESCRIPTION OF THE DRAWINGS

FIG. 1 is a perspective view of a pair of glass parison-forming dies known as ‘blank’ molds pursuant to an embodiment of the invention to form a parison.

FIG. 2 is a similar view of the pair of glass parison-forming dies of FIG. 1 with the dies shown schematically in phantom lines to reveal the internal cooling passages provided in the die bodies pursuant to this embodiment of the invention.

FIG. 3 is a perspective view of the pair of fugitive patterns used in the lost wax investment casting process to cast the dies of FIG. 1.

FIG. 4 is a perspective view of one of a pair of parison-forming or bottle-forming dies having exterior cooling fins and ribs investment cast integrally on an exterior region of the one die pursuant to another embodiment of the invention. The other die of the pair of dies would be provided with similar integrally cast cooling fins and ribs.

FIG. 5 is sectional view of a blank mold (die body) showing a non-linear cooling passage having a surface generally following the curved contour of the molding surface of the die pursuant to another illustrative embodiment of the invention and having cooling passage sections of different cross-sectional size and having heat absorbing elements, such as fins and bumps, cast on the die body extending into the cooling passage.

### DESCRIPTION OF THE INVENTION

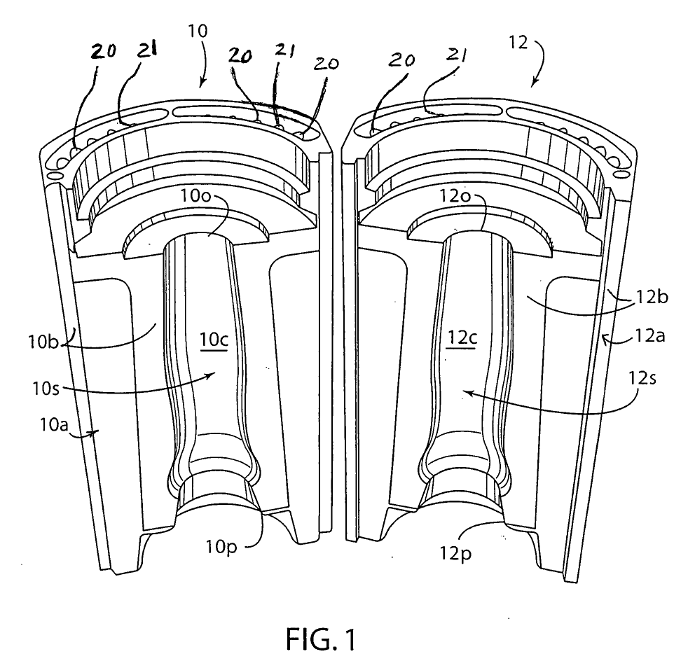

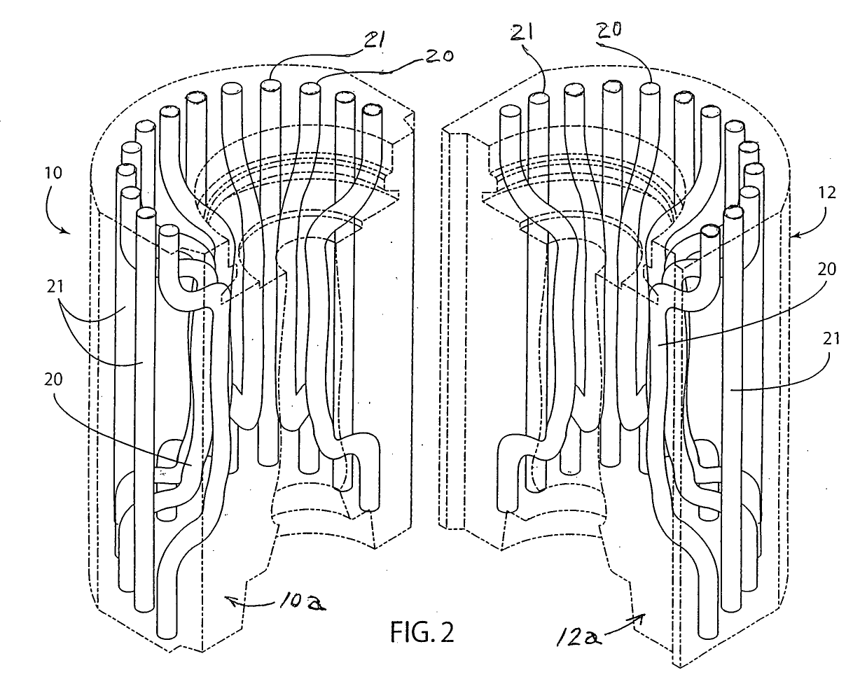

Referring to FIGS. 1 and 2, a pair of parison-forming dies 10, 12 known as ‘blank’ molds are shown for molding a ‘gob’ of molten glass to form a parison therebetween in the bottle making process described above. The dies 10, 12 include respective die bodies 10a, 12a having surfaces 10b, 12b which mate and contact together when the dies are closed or pressed together in a bottle making machine.

The die bodies include respective mold cavity regions 10c, 12c that form a complete molding cavity having the three dimensional shape of the parison when the dies 10, 12 are closed or pressed together in the bottle making machine. The mold cavity regions are defined by respective molding surfaces 10s, 12s on the die bodies 10a, 12a. As is shown in FIG. 1, the molding surfaces each has a curved contour to collectively form a portion of the curved outer surface of the parison. In practice of the invention, the molding surfaces 10s, 12s optionally can be provided with a coating that includes, but is not limited to, a nitride, aluminide, boride, electroplated metal or alloy, or other coating that can reduce die wear. A conventional die lubricant, such as carbon, also optionally can be applied to the molding surfaces 10s, 12s to this same end.

The mold cavity formed by the mold cavity regions 10c, 12c is open at the top when the dies 10, 12 are closed or pressed together. The dies bodies include partial top openings 10o, 12o to collectively form the top opening when the dies are closed. After the gob of molten glass has been introduced into the mold cavity, the top opening is closed by a so-called baffle (not shown) of the bottle making machine. The baffle of the bottle making machine closing the top opening forms no part of the invention.

The mold cavity formed by the mold cavity regions 10c, 12c also has an opening at the bottom. The dies bodies include partial bottom openings 10p, 12p to collectively form the bottom opening when the dies are closed. The bottom opening is closed by a ring and plunger assembly (not shown) of the bottle making machine. The plunger is movable into the mold cavity to force the glass gob introduced into the mold cavity to take the shape of the mold cavity in order to form the parison therein. The ring and plunger assembly of the bottle making machine closing the bottom opening forms no part of the invention.

Pursuant to an embodiment of the invention, each die 10, 12 comprises a plurality of cooling passages 20, FIG. 2, extending through the die body and through which passages 20 a cooling fluid, such as cooling air or other gas, a cooling liquid such as water, liquid metal (e.g. a low melting point liquid metal or alloy such as tin), and other fluids, flows, passes or is blown during the glass forming operation to make the parison. The cooling passages 20 are non-linear (i.e. not straight) along at least a portion of their respective lengths in a manner to improve uniformity of heat removal from each die body 10a, 12a when the cooling fluid passes therethrough. Typically, cooling air is blown onto the dies (blank molds) through the passages 20 during the parison forming stage of the bottle forming process to remove heat from the die bodies 10a, 12a. Cooling air or other cooling gas can be blown at subsonic or supersonic velocity through the cooling passages 20, 21. The cooling passages 20, 21 can extend from one end to the other end through the die body 10a, 12a and/or the cooling passages 20,21 can enter and exit the die body at sides thereof in order to provide a desired heat transfer for a given glass configuration.

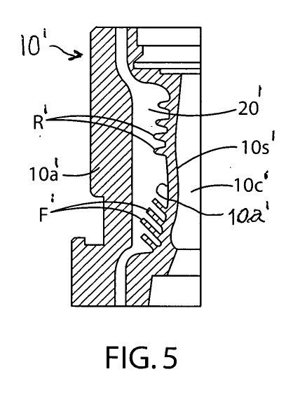

The non-linear (non-straight) portion of each cooling passage 20 preferably is curved in a manner to generally follow the curved contour of the respective molding surfaces 10s, 12s along at least a portion of their length, preferably along much of their length as illustrated in FIGS. 2 and 5. The invention is not limited to the curved passages 20 shown since the invention envisions a cooling passage that may be formed by short segments of straight passages and/or curved passages connected together in a manner that they collectively form a cooling passage that is non-linear (i.e. not straight) so as to generally follow the curved contour of the molding surfaces 10s, 12s along at least a portion of their length.

In FIG. 2, the diameters and spacing of the cooling passages 20 can be adjusted to adjust heat removal and cooling of the die bodies 10a, 12a. The cooling passages 20 are shown as having a circular cross-section along their lengths. However, the invention is not so limited in that the cooling passages can have any suitable shape in cross-section perpendicular to the longitudinal axis of the die body 10a, 12a. For example, one or more of the cooling passages 20 can have an arcuate (e.g. curved) cross-section that generally follows the curve of the mold surface 10s in the peripheral (e.g. circumferential) direction thereof. Such an arcuate cross-section cooling passage can extend around a portion of the periphery (e.g. circumference) of the mold surface 10s, 12s. The arcuate cross-section can incorporate heat absorbing elements and/or turbulators described in the next paragraph.

The passages 20 can also be turbulated in that alternating large and small diameter passage sections are provided along the length of the cooling passages 20. The turbulator(s) cause(s) fluid turbulence in the cooling fluid passage to increase heat transfer between the fluid and the die to improve cooling. The turbulation can be in local regions of the passages 20 or along the entire length of the passages 20, as necessary. In addition, one or more ribs, ridges, fins, bumps, posts or other projecting heat absorbing elements extending from the die body into the cooling passages can be provided for improving heat transfer from the die body to the cooling fluid; see FIG. 5 discussed below. Alternately, the cooling passages can include rib-shaped cavities, ridge-shaped cavities, fin-shaped cavities, or other recessed heat absorbing elements that extend from the cooling passage into the die body to this end. The turbulators or heat absorbing elements can be formed by suitably configuring the refractory cores 50, 51 discussed below to impart such features to the die body cast about the cores. Alternately, the turbulators or heat absorbing elements can be formed on the interior and/or exterior of the metallic tubular members 50′, 51′ discussed below.

In FIG. 5, a blank mold (die) 10′ pursuant to an illustrative embodiment of the invention is shown having a non-linear cooling passage 20′ generally following the curved contour of the molding surface 10s' along a portion of its length pursuant to an embodiment of the invention where like features of previously-described embodiments are represented by like reference numerals primed. The cooling passage 20′ includes a non-linear inner cooling passage surface 20a′ adjacent the molding surface 10s′ of the die body 10a′ to this end. In this illustrative embodiment, the cooling passage 20′ includes sections along its length of different cross-sectional size and further includes heat absorbing elements, such as fins F′ and bumps R′, cast or otherwise formed on the die body so as to extend into the cooling passage 20′ to contact cooling fluid flowing therethrough. The fins F can extend completely across the cooling passage 20′ from inner surface 20a′ to the opposite outer surface of the cooling passage so long as the fins are separated from one another in the peripheral (e.g. circumferential) direction by gaps providing cooling fluid flow paths or are provided with fin openings for the cooling fluid to flow therethrough.

Moreover, referring to FIG. 2, the cooling fluid passages 20 can be employed in conjunction with linear (i.e. straight) cooling fluid passages 21 extending end-to-end through the die body 10, 12. In FIG. 2, cooling fluid passages 20 and 21 are shown arranged in an alternating sequence around the periphery of each die body 10a, 12a for purposes of illustration and not limitation. The straight cooling fluid passages 21 are optional in practice of the invention. In addition, it is not necessary for the cooling passages 20, 21 to extend end-to-end through the die body 10a, 21a, since they may enter into or exit out the side of the die body 10a, 12a in order to provide a desired heat transfer for a given glass configuration.

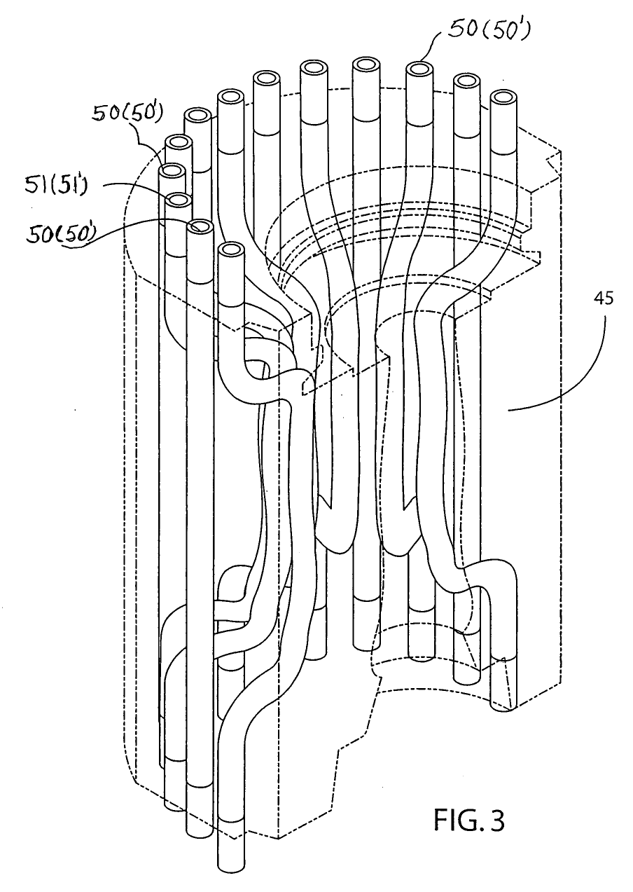

Each die body 10a, 12a described above and shown in FIG. 1 preferably is investment cast using refractory molds having fugitive refractory cores therein to form the cooling passages 20, 21 inside the die body. For example, referring to FIG. 3, a fugitive (e.g. wax or plastic) pattern 45 is shown for use in making the die body 10 or 12. The pattern 45 has the shape of the desired die body. The pattern 45 includes fugitive curved ceramic core tubes or rods 50 (tubes shown) having the shape of the passages 20 and straight ceramic core tubes or rods 51 (tubes shown) having the shape of passages 21. The core tubes or rods 50, 51 are incorporated in the pattern 45 by disposing the preformed ceramic core rods in a pattern molding cavity (e.g. a pattern injection molding cavity when the pattern is a wax material) and introducing molten pattern material (e.g. molten wax material) into the pattern molding cavity to solidify about the core tubes or rods 50, 51. The core tubes or rods 50, 51 can be made as a monolithic core or multi-part core of silica, quartz or other suitable ceramic or refractory core material which can be removed by chemical leaching (e.g. caustic leaching), water blasting, abrasive media blasting, drilling or other machining, or otherwise from the cast die.

The pattern 45 having the core tubes or rods 50, 51 therein is invested in ceramic material pursuant to the well known lost wax investment process wherein the pattern is repeatedly dipped in ceramic slurry, drained of excess slurry, and then stuccoed with coarse ceramic stucco to build up a ceramic shell mold on the pattern. The pattern then is selectively removed from the shell mold by melting the pattern or using other pattern removal processes, leaving a ceramic shell mold having the ceramic cores 50, 51 in the mold cavity thereof. Then, the ceramic shell mold is fired to develop mold strength for casting.

To cast the die body 10 or 12, the shell mold is preheated to an appropriate casting temperature and molten metallic material is poured into the mold and solidified to form the die body 10 or 12. The shell mold is removed from the investment cast die body 10 by a conventional knock-out operation, and the ceramic core, tubes, or rods 50, 51 then are removed by chemical leaching in a caustic medium or otherwise, leaving the investment cast die body 10 or 12 having the cooling fluid passages 20, 21 where the core, tubes, or rods 50, 51 formerly resided.

The dies 10, 12 preferably are investment cast of metal alloys having resistance to degradation in air and to molten glass at the elevated temperatures employed in the glass forming operation. For example, the dies can comprise an iron base alloy having a nominal composition, in weight %, consisting essentially of 19.75% Co, 20.0% Ni, 0.20% C, 1.5% Mn, 1.0% Si, 21.25% Cr, 2.5% W, 3.0% Mo, 1.0% Nb and 0.15% N with the balance Fe. This alloy corresponds to Multimet iron base N155 alloy (N155 is a trademark) having a published composition of, in weight %, 0.08% to 0.16% C, 20% to 22.5% Cr, 18.5% to 21% Co, 1% to 2% Mn, 2.5% to 3.5% Mo, 19% to 21% Ni, Nb and Ta wherein Nb+Ta is 0.75% to 1.25%, 0.1% to 0.2% N, 2% to 3% W, and balance Fe.

Alternately, the dies 10, 12 can be made of heat and corrosion resistant nickel alloys such as a nickel base superalloy including, but not limited to, commercially available IN-718, IN-713LC, and MM-247, to this end. The dies 10, 12 alternately can be made of heat and corrosion resistant cobalt alloys such as a cobalt base superalloy including, but not limited to, commercially available cobalt superalloys to this end. The dies 10, 12 still further can alternately be made of heat and corrosion resistant refractory metals such as W, Nb, Mo, Ta, Zr, or Hf, or alloys thereof one with another or with other metal(s). Moreover, the dies 10, 12 alternately can be made of conventional cast iron, bronze, aluminum-bronze alloy, and aluminum-nickel bronze alloy.

The dies can be cast in conventional manner to provide a die microstructure having a coarse grain size or a fine grain size. Pursuant to one embodiment, the dies 10, 12 are cast by the lost wax investment casting process to provide a coarse or fine equiaxed grain microstructure, or by the so-called MX casting process described in U.S. Pat. No. 4,832,112 to produce a very fine (small) and/or cellular equiaxed grain microstructure, such as an ASTM 2 or less grain size in the die bodies 10a, 12a, as described in the patent, which is incorporated herein by reference. The dies can be cast by any suitable casting process including, but not limited to, countergravity casting, permanent mold casting, plaster mold casting, die casting, sand casting, and others. The molding surfaces 10s, 12s as well as other surfaces/features of the die body optionally can be machined and/or coated after casting of the die body.

Pursuant to another illustrative embodiment of the invention, the glass-forming die 10, 12 can be made by forming a fugitive pattern having a shape of the die to be made as shown in FIG. 3 wherein the pattern 45 includes the curved contour surface that is a precursor to the curved contour molding surface of the die to be made. In this illustrative embodiment, the pattern 45 includes one or more permanent (non-fugitive) tubular metallic insert members in lieu of the refractory cores 50, 51 wherein the tubular metallic insert members are designated with the alternative reference numerals 50′, 51′ in FIG. 3.

The tubular metallic insert members 50′, 51′ are disposed in the pattern 45. Some tubular metallic members 50′ are non-linear along at least a portion of their length, while other tubular metallic insert members 51′ are straight or linear as described for the cores 50, 51 of FIG. 3 for the same reasons.

The pattern 45 with the tubular metallic insert members 50′, 51′ therein is invested in a refractory material to form a refractory mold on the pattern as described above. The pattern is removed as described above, leaving the tubular members 50′, 51′ in the mold cavity of the refractory mold. Molten metallic material then is introduced in the mold cavity of refractory mold about the tubular metallic insert members 50′, 51′ for solidification therein to form the die having the tubular metallic members 50′, 51′ permanently disposed therein to form cooling passages inside the tubular metallic insert members 50′, 51′ for receiving the cooling fluid. The die of this illustrative embodiment thus differs from the die 10 shown in FIGS. 1-2 in having the non-linear and straight tubular metallic insert members 50′, 51′ therein in lieu of the cooling passages 20, 21.

The tubes 50′, 51′ can be made of the same or different metallic material depending upon the temperature profile, uniform or non-uniform, desired for the parison. For example, in one embodiment, tubes 50′ and 51′ both can be made of copper or stainless steel. In another embodiment, tubes 50′ can be made of a metallic material different from that of tubes 51′. Alternately, each tubes 50′ and/or 51′ can be made of two or more different metallic materials having different thermal conductivities. For example, tube 50′ and/or 51′ can comprise a copper tube section and another tube section comprising stainless steel wherein the tube sections are joined together end-to-end by welding or other joining technique.

Pursuant to another illustrative embodiment of the invention, the glass-forming die 10, 12 can be made by powder metallurgy processes where metallic powder material is placed in a deformable metal container (not shown) having the shape of the die and having cores 50, 51 or tubular metallic insert members 50′,51′ disposed in the container. The container is sealed and cold and/or hot isotatically pressed in conventional manner to consolidate the metallic powder material about the cores 50, 51 or about the tubular metallic insert members 50′,51′. When cores are employed, the container and cores then are removed to leave the die having the cooling passages therein corresponding to locations where the cores formerly resided. Alternately, when the tubular metallic insert members are employed, the can then is removed, leaving the die with the tubular metallic insert members 50′, 51′ therein. The consolidated powder metal die body optionally can be heat treated as desired to develop desired mechanical properties.

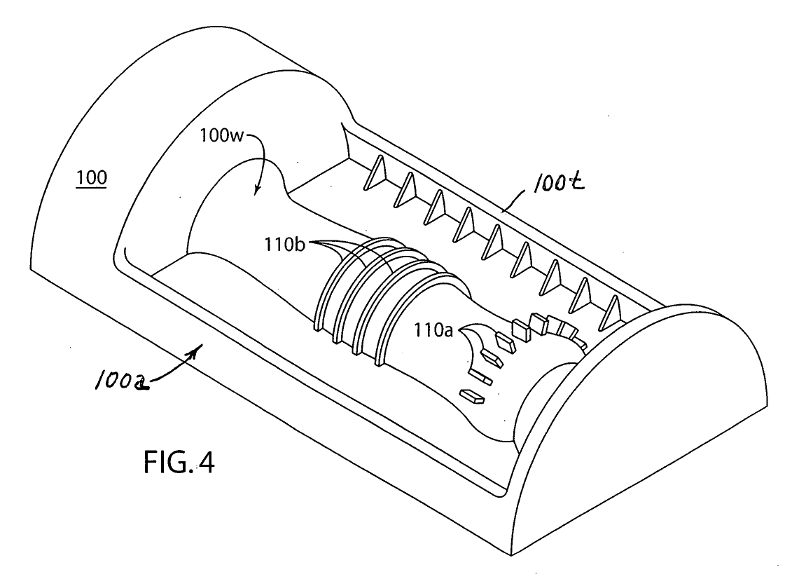

Pursuant to another embodiment of the invention shown in FIG. 4, a glass-forming die 100 is provided having no cooling fluid passages therein, but instead having one or more projections, such as cooling fins 110a and/or ribs 110b, extending from an exterior region 110e of the die body 10a in a manner to improve removal of heat from the region. This die body would be mated with a similar die body having similar features to form a complete ‘blank’ mold (parison-forming die) or a finish die (bottle-forming die).

In particular, the back wall 100w of the die body 100 conforms to the same contour as the mold cavity region (not shown) on the opposite side of the die body (corresponding to mold cavity region 10c or 12c of FIGS. 1 and 2) as a result of the die body 100 having a substantially constant wall thickness in the mold cavity region of the die body. The wall thickness of the die body 100 at other regions can be constant or can be infinitely varied for cooling and thermal fatigue considerations. Local hot spot areas of the die body may require extra cooling and this is accomplished by adding cooling or ‘radiator’ fins 110a and cooling ribs 110b, which help dissipate excess thermal energy especially when cooling fluid is passed across the fins and ribs. Framing of the die body with thicker walls loot at the periphery can help to accommodate the mechanical energy created when the dies rapidly open and close during the 4 second cycle.

The projections, such as cooling fins 110a and/or ribs 110b, extending from an exterior region 110e of the die body 100a can be cast integrally with the die body, can be machined on the cast die body, and/or can be formed separately of the same or different material as the die body and then attached to the die body 100a.

The die body 100 of FIG. 4 can be cast as described above but without the need for ceramic core tubes or rods or tubular metallic insert members from the oxidation and corrosion resistant iron base and nickel base alloys described above.

It should be understood that the invention is not limited to the specific embodiments or constructions described above but that various changes may be made therein without departing from the spirit and scope of the invention as set forth in the appended claims.

We claim

1. A glass-forming die, comprising a die body having a molding surface with a curved contour to form at least a portion of a glass article to be made, said body having at least one cooling passage in the body, said at least one cooling passage being non-linear along at least a portion of its length.

2. The die of claim 1 wherein a non-linear portion of said at least one cooling passage generally follows said curved contour along at least a portion of the length of said curved contour.

3. The die of claim 1 wherein said at least one cooling passage is curved in a manner to generally follow said curved contour along at least a portion of the length of said curved contour.

4. The die of claim 1 wherein said molding surface forms at least a portion of a bottle.

5. The die of claim 1 which is a cast metal or alloy, or consolidated metallic powder material.

6. The die of claim 1 which comprises a metallic material comprising a nickel alloy, cobalt alloy, or a refractory metal or alloy.

7. The die of claim 1 which comprises iron, iron alloy, bronze, aluminum bronze alloy, or aluminum-nickel bronze alloy.

8. The die of claim 1 which comprises consolidated metallic powder material.

9. The die of claim 1 wherein the at least one cooling passage includes a turbulator to improve heat transfer from the die body to the cooling fluid.

10. The die of claim 1 wherein the at least one cooling passage includes a heat absorbing element therein to improve heat transfer from the die body to the cooling fluid.

11. The die of claim 10 wherein the heat absorbing element comprises one or more ribs, ridges, fins, bumps, posts or other projecting heat absorbing elements extending from the die body into the cooling passage

12. The die of claim 1 which has a metallic die body with a grain size of ASTM 2 or less.

13. A glass-forming die, comprising a die body having a molding surface with a curved contour to form at least a portion of a glass article to be made and further having at least one heat radiating element on an exterior region of said die body in a manner to improve removal of heat from said region.

14. The die of claim 13 wherein said at least one element comprises a cooling fin or rib.

15. The die of claim 13 which has a substantially constant wall thickness so that a back wall of the die body has the same contour as the oppositely facing molding surface.

16. The die of claim 13 wherein said molding surface forms at least a portion of a bottle.

17. The die of claim 13 which is cast wherein said element is integral with said body by being cast as part of the die body, by being machined on the die body, or by being formed as a separate component and attached to the die body.

18. The die of claim 13 which comprises a metallic material comprising a nickel alloy, cobalt alloy, or a refractory metal or alloy.

19. The die of claim 13 which comprises iron, iron alloy, bronze, aluminum bronze alloy, or aluminum-nickel bronze alloy.

20. The die of claim 13 which has a metallic die body with a grain size of ASTM 2 or less.

21. A method of making a glass-forming die, comprising forming a fugitive pattern having a shape of the die to be made, said pattern having a curved contour surface that is a precursor to a curved contour molding surface of the die to be made and having at least one fugitive refractory core disposed inside the pattern and being non-linear along at least a portion of its length, investing the pattern in a refractory material to form a refractory mold on the pattern, removing the pattern from the mold, leaving the core in the mold, introducing molten metallic material in the mold for solidification therein to form said die, and removing the core from the die.

22. The method of claim 21 wherein the non-linear portion of said core generally follows the curved contour of said curved contour surface along at least a portion of the length of said curved contour.

23. The method of claim 21 wherein said core is curved in a manner to generally follow said curved contour surface along at least a portion of the length thereof.

24. The method of claim 21 wherein the core is removed by selectively leaching the core from the mold.

25. The method of claim 21 including providing the core with a recess in the shape of a heat absorbing element to be cast integrally on the die so as to extend into the cooling passage.

26. A method of making a glass-forming die, comprising forming a fugitive pattern having a shape of the die to be made, said pattern having a curved contour surface that is a precursor to a curved contour molding surface of the die to be made and having at least one permanent tubular member disposed in the pattern and being non-linear along at least a portion of its length, investing the pattern in a refractory material to form a refractory mold on the pattern, removing the pattern from the mold, leaving the tubular members in the mold, and introducing molten metallic material in the mold about the tubular members for solidification therein to form said die having tubular members therein.

27. The method of claim 26 wherein the non-linear portion of said at least one tubular member generally follows the curved contour of said curved contour surface along at least a portion of the length of said curved contour.

28. The method of claim 26 wherein said at least one tubular member is curved in a manner to generally follow said curved contour surface along at least a portion of the length thereof.

29. A method of making a glass-forming die, comprising forming a fugitive pattern having a shape of the die to be made, said pattern having at least one heat radiating element on an exterior region of said pattern, investing the pattern in a refractory material to form a refractory mold on the pattern, removing the pattern from the mold, and introducing molten metallic material in the mold for solidification therein to form said die.

30. The method of claim 29 wherein said element has a shape of a fin or rib.

31. Method of removing heat from a glass-forming die, comprising flowing a cooling fluid through at least one cooling passage in a die body having a molding surface with a curved contour to form at least a portion of a glass article to be made wherein the cooling passage is non-linear along at least a portion of its length proximate the molding surface.

32. The method of claim 31 wherein the cooling fluid flows through a non-linear portion of said at least one cooling passage that generally follows said curved contour along at least a portion of the length of said curved contour.

33. The method of claim 31 wherein the cooling fluid comprising liquid metal is flowed through said at least one cooling passage that is curved in a manner to generally follow said curved contour along at least a portion of the length of said curved contour.
